(19) United States
(12) Patent Application Publication
(10) Pub. No.: US 2013/0136940 A1
(43) Pub. Date: May 30, 2013

(54) WELDING SYSTEM, WELDING PROCESS, AND WELDED ARTICLE

(71) Applicants: Dechao LIN, Greer, SC (US); Srikanth Chandrudu KOTTILINGAM, Simpsonville, SC (US); Yan CUI, Greer, SC (US); David Edward SCHICK, Greenville, SC (US); Brian Lee TOLLISON, Honea Path, SC (US)

(72) Inventors: Dechao LIN, Greer, SC (US); Srikanth Chandrudu KOTTILINGAM, Simpsonville, SC (US); Yan CUI, Greer, SC (US); David Edward SCHICK, Greenville, SC (US); Brian Lee TOLLISON, Honea Path, SC (US)

(73) Assignee: GENERAL ELECTRIC COMPANY, Schenectady, NY (US)

(21) Appl. No.: 13/304,969

(22) Filed: Nov. 28, 2011

(51) Int. Cl. B23K 26/00; B32B 9/04; B23K 9/16

(52) U.S. Cl. 428/544; 219/74; 219/121.63; 219/121.64

(57) ABSTRACT

A welding system, welding process and welded article are disclosed. The system includes a laser welding apparatus, a GMAW apparatus, and a GTAW apparatus. The laser welding apparatus, the GMAW apparatus, and the GTAW apparatus are positioned to weld an article along a weld path. The process includes providing a welding system having a laser welding apparatus, a GMAW apparatus, and a GTAW apparatus. The process further includes welding an article with one or more of the laser welding apparatus, the GMAW apparatus, and the GTAW apparatus. The welded article includes a weld formed by welding from a GMAW apparatus, a laser welding apparatus, and a GTAW apparatus.

### FIELD OF THE INVENTION

The present invention is directed to welding systems, welding processes, and welded articles. More specifically, the present invention is directed to welding with three or more types of welding apparatuses.

### BACKGROUND OF THE INVENTION

Welding is a continuously developing technology. The demand on properties of articles formed by welding and/or repaired by welding is continuously increasing. Products are consistently subjected to higher temperatures, harsher applications, and more corrosive environments. Known techniques attempt to address these demands but are not able to adequately meet them.

One known welding processes use gas metal arc welding (GMAW). Gas metal arc welders can make a weld deposition on the joint but with a shallow penetration. In addition, spatter happens due to the metal transfer from the consumable electrode to the molten pool under the arc on the substrate. To remove the spatter, additional finishing techniques are used. Such techniques add costs to the overall process and can result in inconsistent welding.

Another known welding process uses laser welding. Laser welding can make deeper penetration welds because of its high-energy density. However, the small size of the laser beam limits the joint fit-up and can be undesirably lacking in fusion due to inconsistent or undesirably low power limitations.

Another known welding process uses gas tungsten arc welding (GTAW). Gas tungsten arc welders use an arc energy established between a non-consumable electrode and the substrate. Filler metal may apply in the welding application. There is no spatter in a GTAW process with appropriate settings. However, the GTAW process has a slow travel speed that limits productivity.

A recent developed welding process combines a laser welding with a gas metal arc welding. When the two welding process are used together, such welding processes are known as hybrid welding processes. Hybrid welding processes produce welds having several positive attributes. Such welds can reduce the cost in joint preparation, speed up the welding process, reduce the rework, and produce higher quality welds. However, further improvement is still desirable. For example, hybrid welding processes can produce spatter, can involve labor or operational costs, can involve laser energy loss due to spatter reflection, and can have weld quality concerns in some applications. In addition, spatter may disturb the laser keyhole stability.

A welding system, welding process, and welded article not suffering from one or more of the above drawbacks would be desirable in the art.

### BRIEF DESCRIPTION OF THE INVENTION

In an exemplary embodiment, a welding system includes a laser welding apparatus, a GMAW apparatus, and a GTAW apparatus. The laser welding apparatus, the GMAW apparatus, and the GTAW apparatus are positioned to produce a combined molten pool to weld an article along a weld path.

In another exemplary embodiment, a welding process includes providing a welding system having a laser welding apparatus, a GMAW apparatus, and a GTAW apparatus. The process further includes welding an article with one or more of the laser welding apparatus, the GMAW apparatus, and the GTAW apparatus.

In another exemplary embodiment, a welded article includes a weld. The weld is formed by welding from a GMAW apparatus, a laser welding apparatus, and a GTAW apparatus.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a side view of an exemplary welding system according to an embodiment.

FIG. 2 is a top view of an exemplary welded article according to an embodiment with a hybrid laser weld on a first portion, a tribrid laser weld on a second portion, and a GTAW weld on a third portion.

FIG. 3 is a section view along line 3-3 of FIG. 2 of a weld formed by an exemplary GTAW process according to an embodiment.

FIG. 4 is a section view along line 4-4 of FIG. 2 of a weld formed by an exemplary hybrid laser/GMAW process according to an embodiment.

FIG. 5 is a section view along line 5-5 of FIG. 2 of an exemplary weld formed by an exemplary tribrid GTAW/laser/GMAW process according to an embodiment.

Wherever possible, the same reference numbers will be used throughout the drawings to represent the same parts.

### DETAILED DESCRIPTION OF THE INVENTION

Provided is an exemplary welding system, welding process, and welded article. Embodiments of the present disclosure decrease spatter, decrease rework, reduce or eliminate unnecessary labor, reduce costs, increase weld quality, or combinations thereof.

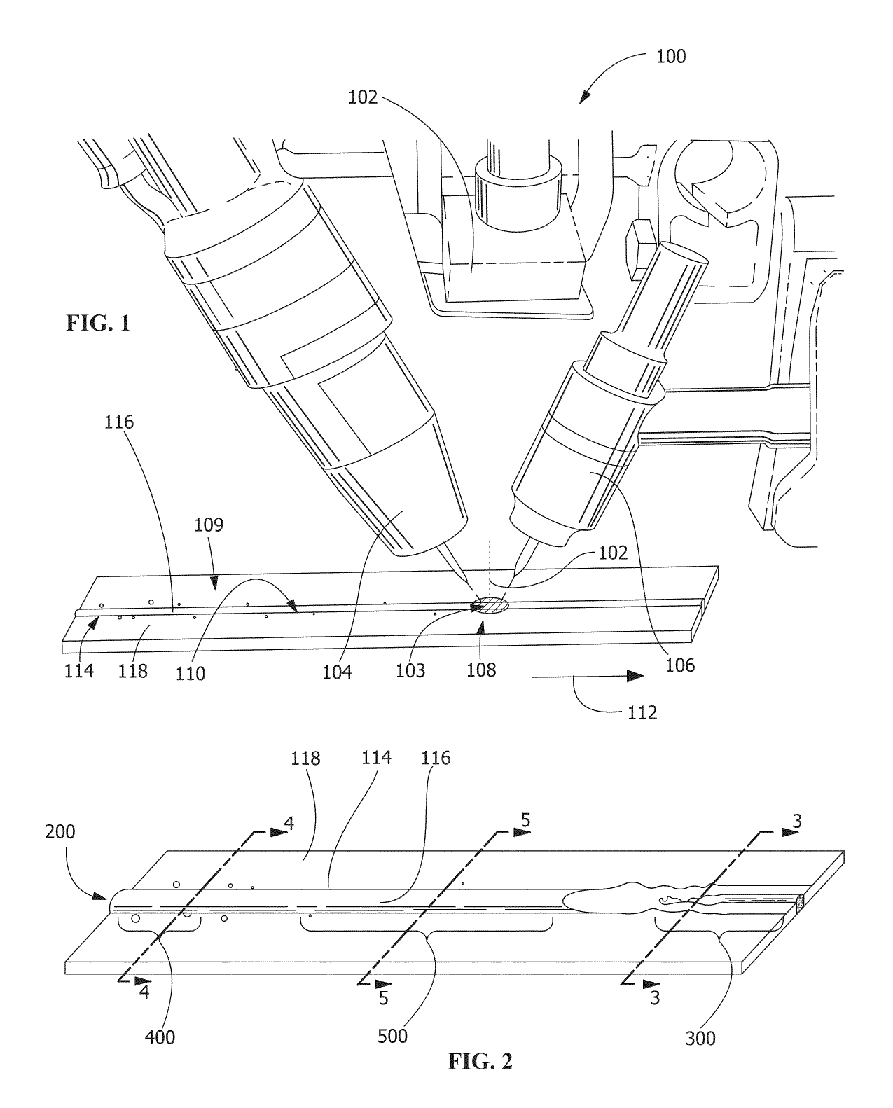

Referring to FIG. 1, according to an embodiment, an exemplary welding system 100 includes a laser welding apparatus 102, a gas metal arc welding (GMAW) apparatus 104, and a gas tungsten arc (GTAW) welding apparatus 106 for welding a first workpiece 108 along a weld path 110 to a second workpiece 109 to form a weld along the welding direction 112. The exemplary welding process includes welding the first workpiece 108 and the second workpiece 109 with one or more of the laser welding apparatus 102, the GMAW apparatus 104, and the GTAW apparatus 106.

The system 100 includes any suitable arrangement of welding apparatuses. In one embodiment, the system 100 is arranged such that the weld path 112 includes welding from the GMAW apparatus 104 first, welding from the laser welding apparatus 102 second, and welding from the GTAW apparatus 106 third. In this embodiment, three heating sources (such as the laser welding apparatus 102, the GMAW apparatus 104, and the GTAW apparatus 106) share a common molten pool 103. As used herein the term “common molten pool” refers to a molten pool combing two or more molten pools together (for example, a laser molten pool, a GMAW molten pool, and a GTAW molten pool). In another embodiment, the GMAW apparatus 104 and the laser welding apparatus 102 are placed close enough (0-15 mm) to form a hybrid laser/GMAW, while the GTAW apparatus 106 is positioned to remelt a portion of the solidifying weld to reduce the weld cooling rate to avoid the weld defect formation and to smoothen the weld bead surface. In one embodiment, the system 100 is arranged to reduce or eliminate interference or disturbance between two electric arcs. For example, in one embodiment, the relative position of the GMAW apparatus 104 and the laser welding apparatus 102 is adjustable and/or the relative position of the laser welding apparatus 102 and the GTAW apparatus 106 is adjustable. In one embodiment, with the GMAW apparatus 104 positioned first, the laser welding apparatus 102 operates with the GMAW apparatus 104 second to form a hybrid laser/GMAW to stabilize the GMAW arc.

In another embodiment, the system 100 is arranged such that the weld path 112 includes welding from the GTAW apparatus 106 first, welding from the laser welding apparatus 102 second, and welding from the GMAW apparatus 104 third. In one embodiment, the GTAW apparatus 106, the laser welding apparatus 102, and the GMAW apparatus 104 share the common molten pool 103. In one embodiment, the laser welding apparatus 102 and the GMAW apparatus 104 are positioned close enough (for example, between about 0 mm and about 15 mm) to form a hybrid laser/GMAW, while the GTAW is positioned first and separated from the hybrid laser/GMAW to reduce or eliminate arc interference. In another embodiment, the laser apparatus 102 and the GTAW apparatus 106 are positioned close enough (for example, between about 0 mm and about 15 mm) to form a hybrid laser/GTAW, while the GMAW apparatus 104 is positioned third and separated from the hybrid laser/GTAW to reduce or eliminate arc interference. In one embodiment, the positioning between the GMAW apparatus 104 and the laser apparatus 102 and/or the laser welding apparatus 102 and the GTAW apparatus 106 is adjustable. In an embodiment with the GTAW apparatus 106 positioned first, GTAW operates as a preheater and assists the laser welding apparatus 102 in achieving deeper penetration and spatter mitigation for the GMAW apparatus 104 positioned third.

In another embodiment, the laser welding apparatus 102 in the system 100 uses a laser, for example, splitting a single laser beam into two laser beams. In another embodiment, the system 100 includes a second laser welding apparatus 102 for providing a second laser beam. In these embodiments, one laser beam works with GMAW to form a hybrid laser/GMAW, and another laser beam works with GTAW to form a hybrid laser/GTAW. The GTAW apparatus 106, the GMAW apparatus 104, and the two laser beams apparatus 102 share the common molten pool 103. The positioning of each within the system reduces or eliminates interference or disturbance between two electric arcs. In one embodiment, the GMAW apparatus 104 and the laser welding apparatus 102 adjustable (for example, between about 0 mm and about 15 mm), the laser welding apparatus 102 and the GTAW apparatus 106 are adjustable (for example, between about 0 mm and about 15 mm) based upon the desired application. Additionally or alternatively, in one embodiment, a distance between two lasers and/or the two laser beams is adjustable (for example, between about 0 mm and about 10 mm).

The welding is performed along the weld path 110 at any suitable speed. For example, in one embodiment, the welding speed is about 60 inches per minute (ipm). In other embodiments, the welding speed is between about 30 ipm and about 120 ipm, between about 55 ipm and about 100 ipm, between about 55 ipm and about 70 ipm, between about 60 ipm and about 90 ipm, about 30 ipm, about 55 ipm, about 60 ipm, about 100 ipm, about 120 ipm, or any suitable combination or sub-combination thereof.

In one embodiment, the laser welding apparatus 102 operates within predetermined operational parameters, which is based upon the desired application. For example, in one embodiment, the laser operates at a power of about 2.5 kW. In other embodiments, the laser operates at a power of between about 2.0 kW and about 20.0 kW, between about 2.0 kW and about 8.0 kW, between about 2.5 kW and about 6.0 kW, a power of about 2.0 kW, a power of about 10.0 kW, a power of about 20.0 kW, or any suitable combination or sub-combination thereof.

In one embodiment, the GMAW apparatus 104 operates within predetermined operational parameters. For example, in one embodiment, the GMAW apparatus 104 operates at about 200 A of arc current and 26V of arc voltage, using a pulse or continuous direct mode. In other embodiments, the GMAW apparatus 104 operates between about 100 A of arc current and about 500 A, between about 150 A and about 450 A, between about 200 A and about 400 A, between about 300 A and about 500 A, or any suitable combination or sub-combination thereof. In one embodiment, the voltage is between about 15V and about 35V. In one embodiment, the arc current is a continuous wave current or a pulsed wave, depending upon the desired application.

In one embodiment, the GTAW apparatus 106 operates within predetermined operational parameters. For example, in one embodiment, the GTAW apparatus 106 operates at about 180 A of arc current and 18 v of arc voltage. In other embodiments, the GTAW apparatus 106 operates between 30 A and 500 A. In one embodiment, the GTAW apparatus 106 burns or otherwise removes dirt and oxides from the first workpiece 108 and the second workpiece 109, thereby permitting formation of a higher quality weld in comparison to welds formed without the GTAW apparatus 106. In one embodiment, heat applied from the GTAW apparatus 106 increases the flow characteristics of molten metal used in the welding process, thereby rendering a transition region 114 between a weld center 116 and the base 118 of the first workpiece 108 (see FIGS. 1 and 2) smoother in comparison to welds formed without the GTAW apparatus 106. In another embodiment, heat from the GTAW apparatus 106 decreases the cooling rate of the weld pool so as to prevent weld defect formation. In another embodiment, GTAW generates a molten pool, which provides the trailing GMAW a larger cathode base for GMAW metal transfer so as to reduce or eliminate GMAW spattering. In another embodiment, GTAW generates a molten pool, which reduces the temperature gradient once the laser penetrates through so as to reduce the tendency of defect formation.

In one embodiment, the GTAW apparatus 106 and the laser welding apparatus 102 are arranged and positioned to use the common molten pool 103. In one embodiment, the molten pool for the GTAW apparatus 106 is of a predetermined size, such as, being larger than molten pools used for laser welding. In this embodiment, the predetermined size of the molten pool 103 permits the laser welding apparatus 102 to penetrate deeper than it would otherwise penetrate without increasing the laser power. This also permits the amount of power supplied to the laser welding apparatus 102 to be reduced in comparison to hybrid laser/GMAW welding techniques or laser welding techniques.

In one embodiment, the GMAW apparatus 104 is arranged and positioned to interact with the laser welding apparatus 102. In this embodiment, a cathode at GMAW setting is established on the base 118 of the first workpiece 108 and the second workpiece 109, and interacts with the laser beam of the laser welding apparatus 102. In this embodiment, the molten pool 103, generated by GTAW, combines to the common molten pool and reduces or eliminates spattering of GMAW because the metal transfer from the electrode in the GMAW apparatus 104 is more stable in comparison to welds formed without the GTAW assistance.

Referring to FIG. 2, an exemplary welded article 200 is formed by using the system 100 with various settings. Specifically, the welded article 200 is welded by the GMAW apparatus 104 (see FIG. 1), the laser welding apparatus 102 (see FIG. 1), and the GTAW apparatus 106 (see FIG. 1). The welded article 200 includes one or more regions having predetermined weld characteristics based upon the selected apparatuses used in welding. As will be appreciated, embodiments of the welding process include transitioning from operation with one or more of the GTAW apparatus 106, the laser welding apparatus 102, and the GMAW apparatus 104 to form the regions having differing weld characteristics. In one embodiment, spatter is reduced or eliminated by applying a GTAW to the hybrid laser/GMAW setting.

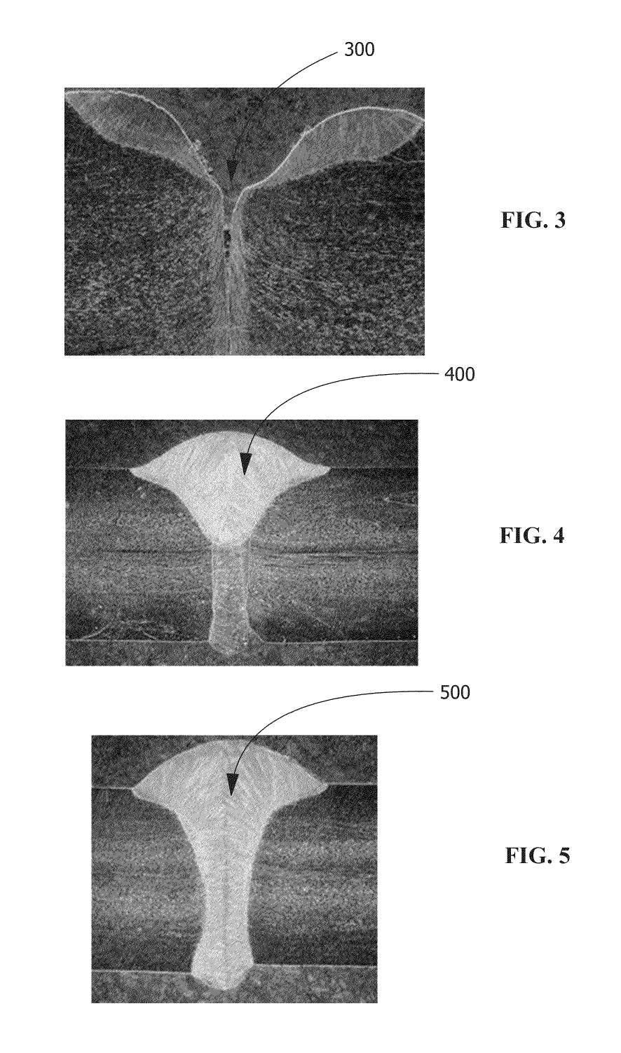

Referring to FIG. 3, in one embodiment, the welded article 200 includes a GTAW welded region 300 (see FIG. 2) formed by using the GTAW apparatus 106 (see FIG. 1). In one embodiment, the GTAW welded region 300 is formed by the system 100 (see FIG. 1). In this embodiment, the GTAW apparatus 106 is used but the laser welding apparatus 102 and the GMAW apparatus 104 are not used, in which to demonstrate the contribution of GTAW in the tribrid GTAW/Laser/GMAW welds.

Referring to FIG. 4, in one embodiment, the welded article 200 includes a hybrid welded region 400 (see FIG. 2) formed by using the laser welding apparatus 102 (see FIG. 1) and the GMAW apparatus 104 (see FIG. 1). In this embodiment, the laser welding apparatus 102 and the GMAW apparatus 104 are used and positioned at a predetermined distance apart to form a hybrid laser/GMAW (for example, in one embodiment, the predetermined distance is between about 0 mm and about 15 mm) but the GTAW apparatus 106 is not used.

Referring to FIG. 5, in one embodiment, the welded article 200 includes a tribrid welded region 500 (see FIG. 2) formed by using the laser welding apparatus 102 (see FIG. 1), the GMAW apparatus 104 (see FIG. 1), and the GTAW apparatus 106 (see FIG. 1). As can be seen in FIG. 5, the profile of the weld in the tribrid welded region 500 (see FIG. 2) is cleaner than the weld in the hybrid welded region 400 (see FIG. 2) in FIG. 4. Under an identical hybrid/GMAW setting, in one embodiment, additional GTAW reduces or eliminates a lack of fusion defect attributable present without the additional GTAW due to the weld profile modification. In addition, the weld in the tribrid welded region 500 (see FIG. 2) is substantially consistent and substantially uniform in microstructure.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A welding system, comprising:
a laser welding apparatus;
a gas metal arc welding apparatus; and
a gas tungsten arc welding apparatus;
wherein the laser welding apparatus, the gas metal arc welding apparatus, and the gas tungsten arc welding apparatus are positioned to produce a combined molten pool to weld an article along a weld path.

2. The system of claim 1, wherein the laser welding apparatus, the gas metal arc welding apparatus, and the gas tungsten arc welding apparatus use a common molten pool.

3. The system of claim 1, wherein the gas tungsten arc welding apparatus and the laser welding apparatus use a common molten pool without the gas metal arc welding apparatus.

4. The system of claim 1, wherein the gas metal arc welding apparatus and the laser welding apparatus use a common molten pool without the gas tungsten arc welding apparatus.

5. The system of claim 1, wherein the laser welding apparatus is positioned between the gas metal arc welding apparatus and the gas tungsten arc welding apparatus.

6. The system of claim 1, wherein the laser welding apparatus forms a split laser beam.

7. The system of claim 1, wherein the laser welding apparatus includes a first laser and a second laser, the first laser providing a first laser beam and the second laser providing a second laser beam.

8. The system of claim 1, wherein a first laser beam operates with the gas metal arc welding apparatus to form a first hybrid welding apparatus and a second laser beam operates with the gas tungsten arc welding apparatus to form a second hybrid welding apparatus.

9. A welding process, comprising:
providing a welding system, the welding system comprising a laser welding apparatus, a gas metal arc welding apparatus, and a gas tungsten arc welding apparatus;
welding an article with one or more of the laser welding apparatus, the gas metal arc welding apparatus, and the gas tungsten arc welding apparatus.

10. The process of claim 9, wherein the welding includes welding from each of the gas metal arc welding apparatus, the laser welding apparatus, and the gas tungsten arc welding apparatus.

11. The process of claim 9, wherein the welding includes using a common molten pool for to weld with the gas tungsten arc welding apparatus and the laser welding apparatus.

12. The process of claim 9, wherein the welding includes using a common molten pool for to weld with the gas metal arc welding apparatus and the laser welding apparatus.

13. The process of claim 9, wherein the welding includes using a common molten pool for to weld with the gas tungsten arc welding apparatus, the gas metal arc welding apparatus, and the laser welding apparatus.

14. The process of claim 9, wherein the welding includes operating the gas tungsten arc welding apparatus but not the laser welding apparatus and the gas metal arc welding apparatus.

15. The process of claim 9, wherein the welding includes operating the laser welding apparatus and the gas metal arc welding apparatus but not the gas tungsten arc welding apparatus.

16. The process of claim 9, wherein the welding includes transitioning between operation of one or more of the gas tungsten arc welding apparatus, the laser welding apparatus, and the gas metal arc welding apparatus.

17. The process of claim 9, wherein the laser welding apparatus forms a split laser beam.

18. The process of claim 9, wherein the laser welding apparatus includes a first laser and a second laser, the first laser providing a first laser beam and the second laser providing a second laser beam.

19. The process of claim 9, wherein a first laser beam operates with the gas metal arc welding apparatus to form a first hybrid welding apparatus and a second laser beam operates with the gas tungsten arc welding apparatus to form a second hybrid welding apparatus.

20. A welded article, comprising:
a weld, the weld being formed by welding from a gas metal arc welding apparatus, a laser welding apparatus, and a gas tungsten arc welding apparatus.
